(19) United States
(12) Patent Application Publication
(10) Pub. No.: US 2007/0213095 A1
(43) Pub. Date: Sep. 13, 2007

(54) RADIO MOBILE TERMINAL DEVICE

(75) Inventor: Chishio Ueno, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd, Osaka (JP)

(21) Appl. No.: 11/573,241

(22) PCT Filed: Aug. 8, 2005
(86) PCT No.: PCT/JP05/14535

§ 371 Date: Feb. 5, 2007

(30) Foreign Application Priority Data
Aug. 9, 2004 (JP) 2004-232189
Aug. 5, 2004 (JP) 2005-228924

(51) Int. Cl. H04B 1/38

(52) U.S. Cl. 455/557

(57) ABSTRACT

There is provided a radio mobile terminal device which makes a connection via an interface automatically connectable to a transmission side or a reception side even when one of the interfaces of the reception side is disabled for connection. The radio mobile terminal device includes a telephone number management unit (112) for managing a telephone number and a terminal type of a partner registered in advance and a dual terminal judgment unit (113) for judging whether the terminal device of the partner is a dual terminal. When a user performs a transmission operation, the telephone number management unit (112) and the dual terminal judgment unit (113) judge whether the partner is a dual terminal and, if a dual terminal, they perform transmission to a telephone number corresponding to the two radio interfaces of the partner. On the other hand, upon detection of a reception request by a radio interface corresponding to a cellular mobile telephone system, it is judged whether the partner transmission is a dual terminal. If the partner is a dual terminal and if the radio interface corresponding to the radio LAN system can be connected, reception is performed by the radio interface.

### TECHNICAL FIELD

The present invention relates to a dual-mode mobile radio terminal device having a radio interface supporting a cellular mobile telephone system and a radio interface supporting a radio LAN system.

### BACKGROUND ART

The communication systems of recent years have been designed for use with a public radio LAN service that is based on a radio LAN that employs a radio scheme such as that described in IEEE802.11. In locations where this public radio LAN service communication system has been arranged, utilization of a radio communication system that takes advantage of high-capacity radio communication is possible.

The popularization of such a public radio LAN service has created a need for a user-friendly dual-mode mobile radio terminal device having a radio interface supporting a radio LAN in addition to the existing cellular mobile telephone system radio interface.

FIG.1 is a block diagram showing an example of a conventional dual-mode mobile radio terminal device having a radio interface supporting a cellular mobile telephone system and a radio interface supporting a radio LAN system.

As shown in FIG. 1, mobile radio terminal device 10 has antenna 11 for cellular communication, antenna 12 for radio LAN communication, control section 13, and operation section 14 having, for example, a set of buttons and a touch panel for user operations. In addition, mobile radio terminal device 10 has display section 15 for visually and auditorily notifying the user of information required for its use, and receiver (speaker) 16 and transmitter (mike) 17 for talking.

Control section 13 of this mobile radio terminal device 10 has cellular communication control section 18 that controls the radio interface for cellular communication, radio LAN communication control section 19 that controls the radio interface for radio LAN communication, and telephone call control section 20.

In FIG. 1, telephone call control section 20 uses the corresponding radio interface via the specified cellular communication control section 18 or radio LAN communication control section 19 to execute the transmission procedure for the telephone call and connect the call path with the partner.

In addition, based on a reception request from cellular communication control section 18 or radio LAN communication control section 19, uses the corresponding radio interface to execute the reception procedure for the telephone call, and connect the call path with the partner.

Furthermore, when the call path is connected, telephone call control section 20 sends the voice data from transmitter 17 using the corresponding antenna 11 or antenna 12 via the corresponding radio interface to transmit to receiver 16 the voice data received by antenna 11 or antenna 12 via the corresponding radio interface.

However, in such a mobile radio terminal device 10 that has multiple radio interfaces, at the time of reception, a call is placed to the telephone number of one of the radio interfaces, and the call path is connected with the partner via the radio interface of the called telephone number.

On the other hand, the user of mobile radio terminal device 10 requests that the radio interface for call path connection be selected taking into consideration factors such as the telephone fee and communication speed in accordance with current connectability, i.e., whether or not the user is in a connectable service area of each radio interface.

One known mobile radio terminal device that meets such a request is a device that, when reception occurs on one of the two interfaces, calls the partner using the other interface, connecting the call path with the partner using the desired line based on user instructions (see Patent Document 1, for example).

In addition, one known telephone call system of this type is a system that, at the time of reception, can judge on the network side the connectability of the mobile radio terminal device and select the line to be connected (see Patent Document 2, for example).
Patent Document 1: Japanese Patent Application Laid-open No. 63-224422
Patent Document 2: Japanese Patent Application Laid-open No. 2003-284144

### DISCLOSURE OF THE INVENTION

Problems to be Solved by the Invention

However, with the above-mentioned conventional dual-mode mobile radio terminal device having a radio interface supporting a cellular mobile telephone system and a radio interface supporting a radio LAN system, the radio interface that is connected is not known.

As a result, such a dual-mode mobile radio terminal device having multiple radio interfaces requires the caller to manually perform a transmission operation to the telephone numbers corresponding to each of the radio interfaces until the call path with the partner can be connected.

In addition, in the case of the mobile radio terminal device of Patent Document 1, when there is reception on one of the two radio interfaces, the other radio interface is used to call the partner and connect the call path, but if that radio interface is not in a connectable state, the user on the reception side must wait for connection while the partner is being called.

Further, the communication system described in Patent Document 2 has a function for selecting the line to be connected by the network side and therefore highly depends on the service of the network side, rendering realization impossible if the service of each radio interface is not coordinated.

An object of the present invention is to provide a mobile radio terminal device which makes a connection via a radio interface automatically connectable to a transmission side or a reception side even when one of the radio interfaces of the reception side is disabled for connection.

Means for Solving the Problem

To solve such problems, the mobile radio terminal device of the present invention has a radio interface supporting a cellular mobile telephone system and a radio interface supporting a radio LAN system and adopts a configuration having a telephone number management section that manages a telephone number and a terminal type of a partner that are registered in advance as registration information; a dual terminal judgment section that judges based on the registration information of the telephone number management section whether the terminal device type corresponding to the telephone number of the partner is a dual-mode mobile radio terminal device having the two radio interfaces; a reception interface selection section that, when the partner is judged as the dual-mode mobile radio terminal device by the dual terminal judgment section, detects a reception request by either of the mobile interfaces and, if there is a reception request on the other radio interface within a predetermined period of time, selects either of the radio interfaces, or, if there is no reception request on the other radio interface within the predetermined period of time, selects the radio interface that detected the reception request; and a telephone call control section that starts the reception process of the reception request from the radio interface selected by the reception interface selection section and connects the call path with the partner.

Advantageous Effect of the Invention

In accordance with the present invention, connection is made via a radio interface automatically connectable to a transmission side or a reception side even when one of the radio interfaces of the reception side is disabled for connection, thereby making it no longer necessary for the user on the reception side to wait for connection while the partner is being called.

### BRIEF DESCRIPTION OF DRAWINGS

FIG. 1 is a block diagram showing an example of a conventional dual-mode mobile radio terminal device;

FIG. 2 is a block diagram showing the configuration of the mobile radio terminal device according to Embodiment 1 of the present invention;

FIG. 3 is a flowchart for the operation of the control section during the transmission operation of the mobile radio terminal device according to Embodiment 1 of the present invention;

FIG. 4 is a flowchart for the operation of the control section upon detection of a reception request from the cellular communication control section of the mobile radio terminal device according to Embodiment 1 of the present invention;

FIG. 5 is a figure showing an example of data managed by the telephone number management section of the mobile radio terminal device according to Embodiment 1 of the present invention;

FIG. 6 is a block diagram showing the configuration of the mobile radio terminal device according to Embodiment 2 of the present invention;

FIG. 7 is a flowchart for the operation of the control section upon detection of a reception request from a communication control section of the mobile radio terminal device according to Embodiment 2 of the present invention;

FIG. 8 is a block diagram showing the configuration of the mobile radio terminal device according to Embodiment 3 of the present invention;

FIG. 9 is a flowchart for the operation of the control section when a telephone call is in progress on the mobile radio terminal device according to Embodiment 3 of the present invention;

FIG. 10 is a block diagram showing the configuration of the mobile radio terminal device according to Embodiment 4 of the present invention;

FIG. 11 is a flowchart for the operation of the control section while a telephone call is in progress on the mobile radio terminal device according to Embodiment 4 of the present invention;

FIG. 12 is a block diagram showing the configuration of the mobile radio terminal device according to Embodiment 5 of the present invention; and

FIG. 13 is a flowchart for the operation of the control section upon detection of a reception request when a telephone call is in progress on the mobile radio terminal device according to Embodiment 5 of the present invention.

### BEST MODE FOR CARRYING OUT THE INVENTION

Now the mobile radio terminal device according to Embodiment 1 of the present invention will be described in detail with reference to the accompanying drawings. The following explanation uses a dual-mode mobile radio terminal device (hereinafter “dual terminal”) having a radio interface supporting a cellular mobile telephone system and a radio interface supporting a radio LAN system as an example of a mobile radio terminal device.

### EMBODIMENT 1

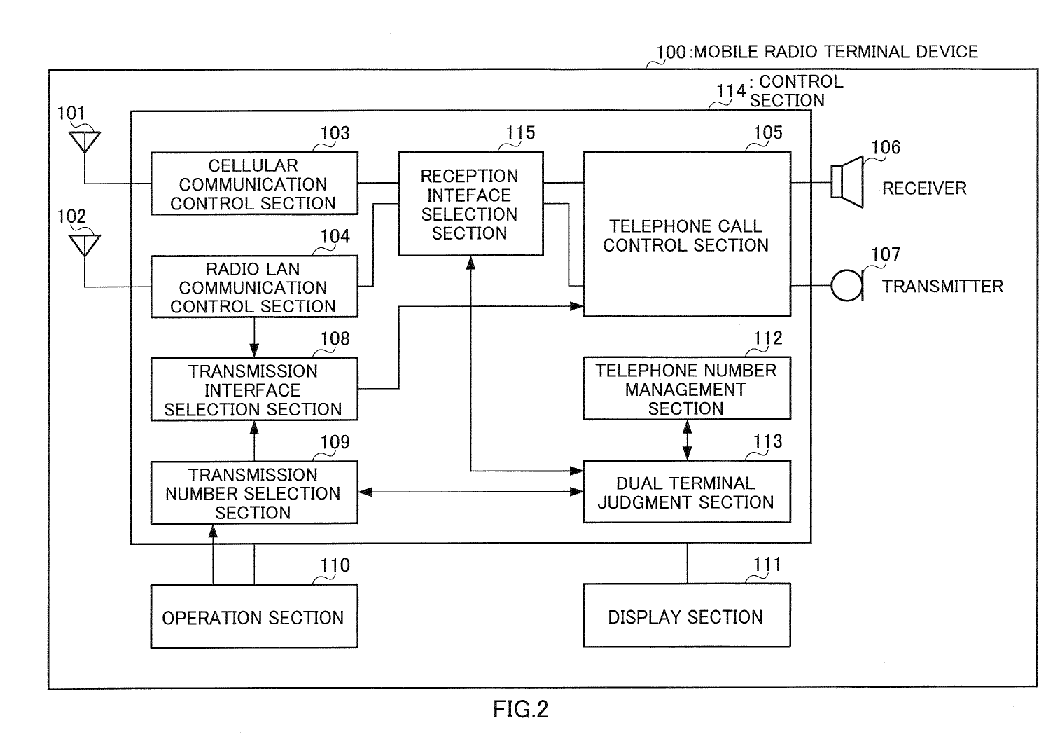

FIG. 2 is a block diagram showing the configuration of the mobile radio terminal device according to Embodiment 1 of the present invention.

As shown in FIG. 2, mobile radio terminal device 100 has antenna 101 for cellular communication, antenna 102 for radio LAN communication, and receiver 106 and transmitter 107 for talking. In addition, mobile radio terminal device 100 has operation section 110 that is provided with, for example, a set of buttons and a touch panel for user operations, display section 111 for visually and auditorily notifying the user of information required for its use, and control section 114.

Control section 114 has cellular communication control section 103, radio LAN communication control section 104, telephone call control section 105, transmission interface selection section 108, transmission number selection section 109, telephone number management section 112, dual terminal judgment section 113 and reception interface selection section 115.

In FIG. 2, cellular communication control section 103 controls the radio interface for cellular communication. Radio LAN communication control section 104 controls the radio interface for radio LAN communication.

Telephone call control section 105 uses the corresponding radio interface via the specified cellular communication control section 103 or radio LAN communication control section 104 to execute the transmission procedure for the telephone call and connect the call path with the partner. In addition, based on a reception request from cellular communication control section 103 or radio LAN communication control section 104, telephone call control section 105 uses the corresponding radio interface to execute the reception procedure for the telephone call and connect the call path with the partner. Furthermore, with the call path connected, telephone call control section 105 sends the voice data from transmitter 107 to the corresponding antenna 101 or antenna 102 via the corresponding radio interface, and transmits to receiver 106 via the corresponding radio interface the voice data received by antenna 101 or antenna 102.

Transmission interface selection section 108 manages the connection status of each radio interface of mobile radio terminal device 100, i.e., whether or not each radio interface is capable of transmission, specifies the radio interface that is in a connectable state, and gives instructions for transmission to telephone call control section 105.

Transmission number selection section 109 extracts the telephone number of the partner corresponding to each of the radio interfaces provided in the terminal device of the partner.

Telephone number management section 112 manages registration information such as the telephone numbers and terminal type of the partner registered in advance.

Dual terminal judgment section 113 judges based on the registration information registered in telephone number management section 112 whether or not the terminal type of the terminal device corresponding to the telephone number of the partner is a dual terminal having two radio interfaces.

Upon detection of a reception request on the cellular communication radio interface, reception interface selection section 115 outputs the telephone number of the partner of the reception request to dual terminal judgment section 113 and, based on the result of the judgment by dual terminal judgment section 113, waits if the partner terminal device is a dual terminal for the reception request on the radio interface supporting the radio LAN system for only a predetermined period of time.

Here, when the reception request of the radio interface supporting the radio LAN system arrives within the predetermined period of time, reception interface selection section 115 denies cellular mobile telephone system reception and begins the reception processing for the reception request from the radio interface supporting the radio LAN system. On the other hand, when there is no reception request from the radio interface supporting the radio LAN system within the predetermined period of time, reception interface selection section 115 begins the reception processing for the reception request from the radio interface of the cellular mobile telephone system.

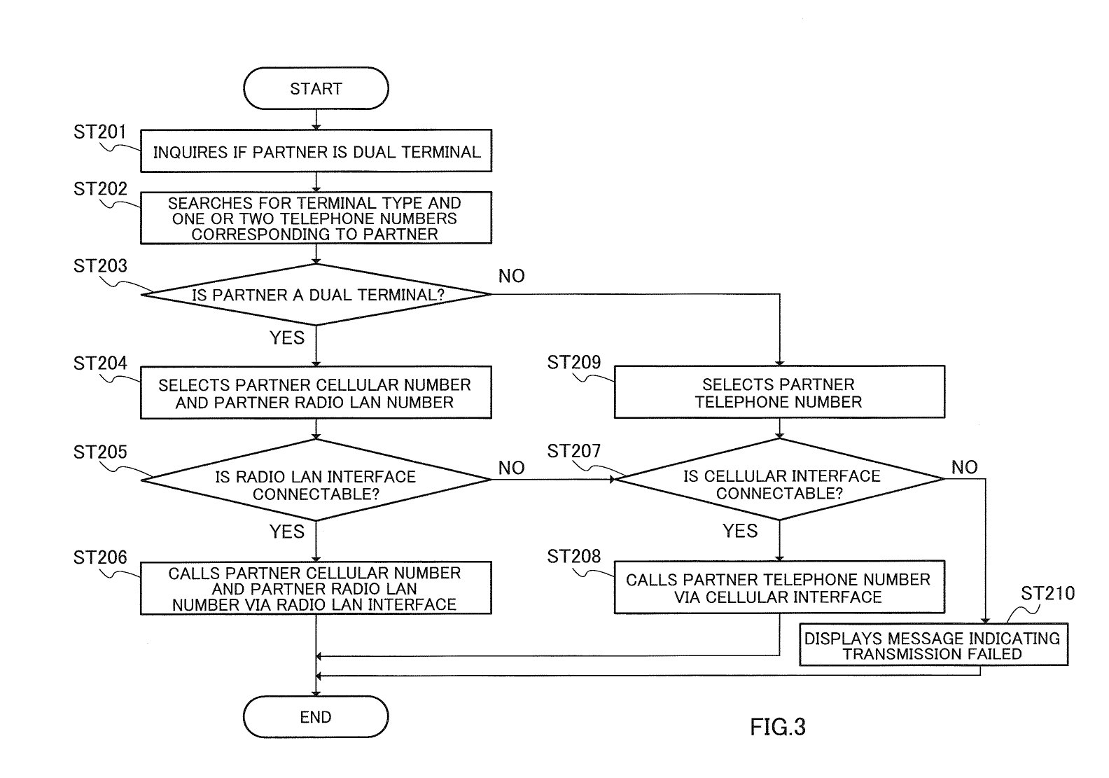

Next, an example of the operation of control section 114 at the time the user of mobile radio terminal device 100 performs a transmission operation using operation section 110 will be described. FIG. 3 is a flowchart for the operation of control section 114 at the time of the transmission operation of the mobile radio terminal device according to the present embodiment.

In FIG. 3, the operation of control section 114 starts when there is a transmission operation from operation section 110, and first transmission number selection section 109 inquires at dual terminal judgment section 113 whether or not the terminal type of the transmitting partner is a dual terminal (step ST201).

As a result, dual terminal judgment section 113 searches in the registration information registered in telephone number management section 112 for the terminal type and telephone number corresponding to the partner, and judges based on the terminal type of the search result whether or not the terminal device is a dual terminal. Then, dual terminal judgment section 113 notifies transmission number selection section 109 of the judgment result and one or two telephone numbers (step ST202).

Here, if the terminal type of the partner is a dual terminal, transmission number selection section 109 can extract two telephone numbers, i.e., the partner cellular number and the partner radio LAN number. If the terminal type of the partner is not a dual terminal, transmission number selection section 109 can extract one telephone number, i.e., either the partner cellular number or the partner radio LAN number.

Next, if the judgment result of dual terminal judgment section 113 indicates the terminal is a dual terminal (step ST203: Yes), transmission number selection section 109 selects and delivers the partner cellular number and partner radio LAN number to transmission interface selection section 108 (step ST204).

Transmission interface selection section 108 checks the connection status of the radio LAN interface, i.e., whether or not the interface is capable of transmission, at radio LAN communication control section 104 (step ST205).

Here, if the radio LAN interface is in a connectable state (step ST205: Yes), transmission interface selection section 108 specifies the radio LAN interface to telephone call control section 105, giving instructions to call the partner cellular number and partner radio LAN number. In accordance with the call instruction, radio LAN communication control section 104 and telephone call control section 105 call the partner cellular number and partner radio LAN number via the radio LAN interface (step ST206). Next, mobile radio terminal device 100 starts the telephone call if the partner answers the call.

On the other hand, if the radio LAN interface is not in a connectable state (step ST205: No), transmission interface selection section 108 checks the cellular interface connection state, i.e., whether or not the interface is capable of transmission, at cellular communication control section 103.

If the cellular interface is in a connectable state (stepST207: Yes), transmission interface selection section 108 specifies the cellular interface to telephone call control section 105, giving instructions to place the call using the partner cellular number or partner radio LAN number. At this time, transmission interface selection section 108 instructs telephone call control section 105 to place the call using the partner cellular number if the partner cellular number exists in the telephone number extracted from telephone number management section 112, or to place the call using the partner radio LAN number if the telephone number extracted from telephone number management section 112 is the partner radio LAN number only.

In accordance with the call instructions, cellular communication control section 103 and telephone call control section 105 call the specified telephone number via the cellular interface (step ST208). Subsequently, mobile radio terminal device 100 starts the telephone call if the partner answers.

In addition, if the judgment result of dual terminal judgment section 113 indicates the terminal is not a dual terminal (step ST203: No), transmission number selection section 109 selects and delivers the telephone number found from telephone number management section 112 to transmission interface selection section 108 (step ST209).

As a result, transmission interface selection section 108 checks the cellular interface connection status, i.e., if the interface is capable of transmission, at cellular communication control section 103. If the cellular interface is in a connectable state (step ST207: Yes), transmission interface selection section 108 specifies the cellular interface to telephone call control section 105, giving instructions to place the call using that partner telephone number.

In accordance with the call instructions, cellular communication control section 103 and telephone call control section 105 call the specified telephone number via the cellular interface (step ST208). Subsequently, mobile radio terminal device 100 starts the telephone call if the partner answers.

In addition, if the cellular interface is not in a connectable state in step ST207 (step ST207: No), transmission failure should be relayed to the user of mobile radio terminal device 100 and is therefore displayed on display section 111 (step ST210).

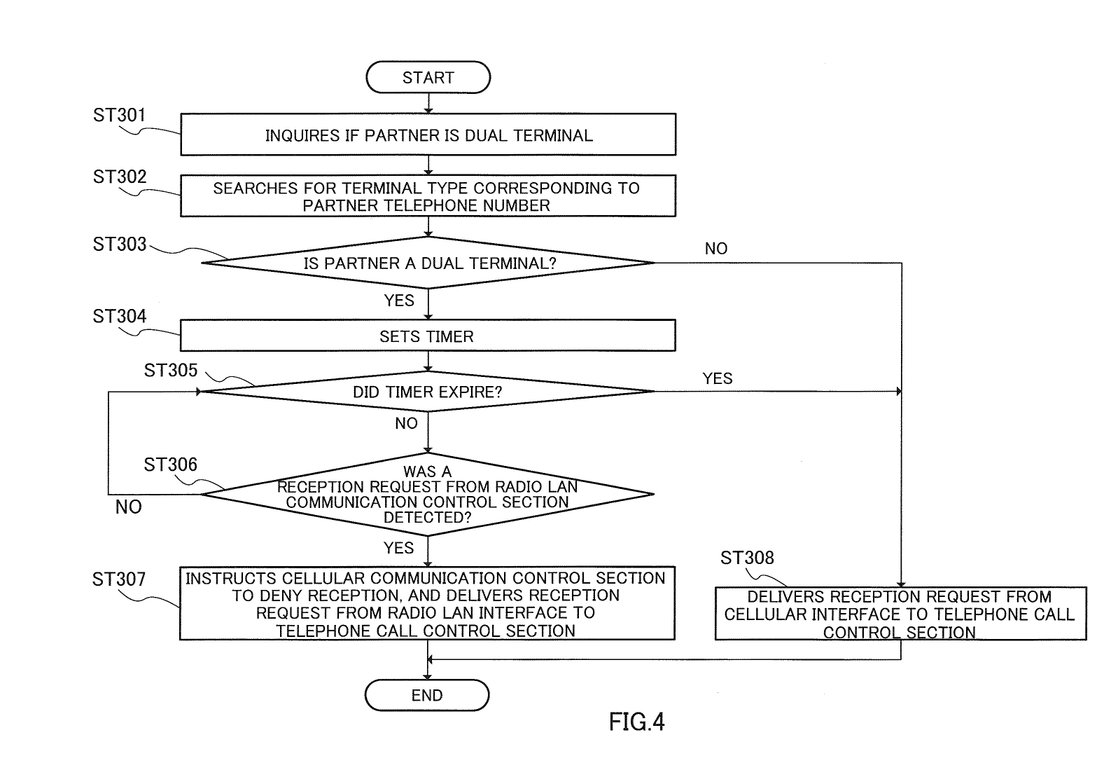

Next, an example of the operation of control section 114 of mobile radio terminal device 100 at the time reception interface selection section 115 detects a reception request from cellular communication control section 103 will be described. FIG. 4 is a flowchart for the operation of control section 114 upon detection of a reception request from cellular communication control section 103 of the mobile radio terminal device according to the present embodiment.

In FIG. 4, operation of control section 114 begins when reception interface selection section 115 detects a reception request from cellular communication control section 103 and, based on the partner telephone number of the reception request, inquires whether or not the terminal device of the partner is a dual terminal at dual terminal judgment section 113 (step ST301).

As a result, dual terminal judgment section 113 searches for the terminal type corresponding to the partner telephone number delivered from telephone number management section 112, judges whether or not the terminal type of the search result is a dual terminal, and delivers the judgment result to reception interface selection section 115 (step ST302).

If the terminal device of the partner is a dual terminal according to the judgment result of dual terminal judgment section 113 (step ST303: Yes), reception interface selection section 115 sets a timer that is designed to expire after a predetermined period of time.(Step ST304)

In addition, reception interface selection section 115 waits for a reception request from radio LAN communication control section 104 (step ST306) up until the moment the above-mentioned timer expires (step ST305: No).

Then, when a reception request is detected from radio LAN communication control section 104 before the above-mentioned timer expires (step ST306: Yes), reception interface selection section 115 instructs cellular communication control section 103 to deny reception of reception requests detected by this interface, and delivers the reception request from the radio LAN interface to telephone call control section 105 (step ST307).

As a result, telephone call control section 105 starts the reception process in accordance with the reception request from the radio LAN interface. Subsequently, a message or symbol indicating reception appears on display section 111 and, if the user receives the display, operates operation section 110, and answers the reception, the telephone call starts.

On the other hand, if the above-mentioned timer expires in step ST305 (step ST305: Yes), reception interface selection section 115 delivers the reception request from the cellular interface to telephone call control section 105 (step ST308).

As a result, telephone call control section 105 starts the reception process in accordance with the reception request delivered from reception interface selection section 115. Subsequently, a message or symbol indicating reception appears on display section 111 and, if the user receives the display, operates operation section 110, and answers the reception, the telephone call starts.

Similarly, if the terminal device of the partner is not a dual terminal according to the judgment result of step ST303 (step ST303: No), reception interface selection section 115 delivers the reception request from the cellular interface to telephone call control section 105 (step ST308).

Then, telephone call control section 105 starts the reception process in accordance with the reception request delivered from reception interface selection section 115. Subsequently, a message or mark indicating reception appears on display section 111, the user receives this display, operates operation section 110, and starts the telephone call if there is an answer to reception.

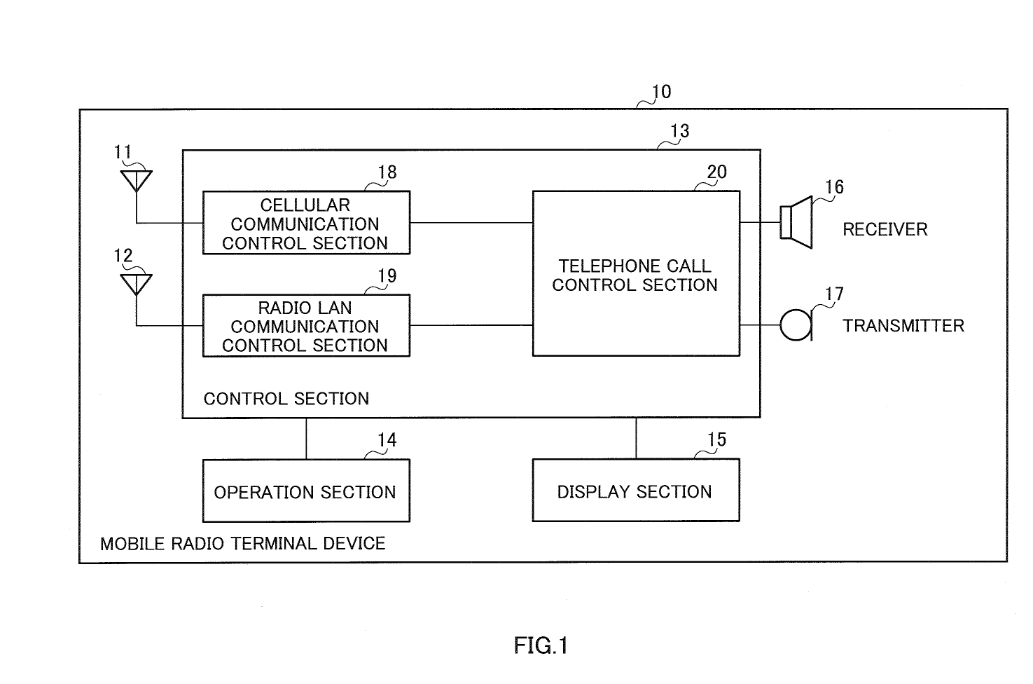

Furthermore, the operation of control section 114 of mobile radio terminal device 100 at the time a reception request from radio LAN communication control section 104 is detected first is the same as that of conventional mobile radio terminal device 10 shown in FIG. 1.

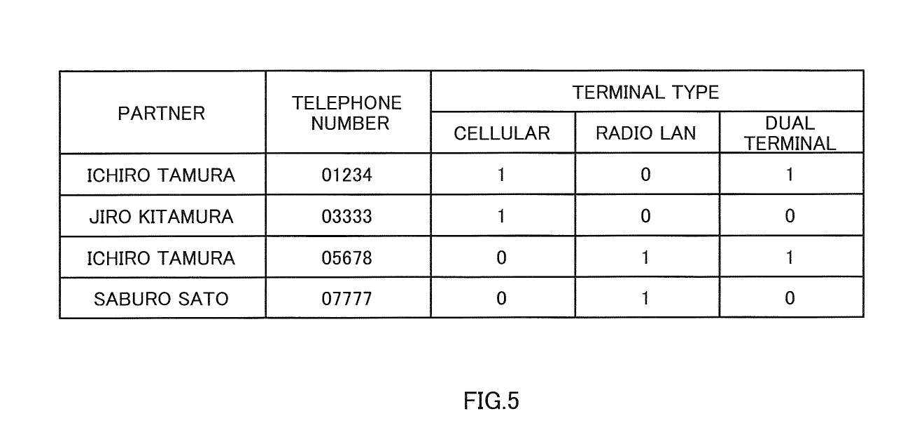

Next, an example of the data managed by telephone call management section 112 of mobile radio terminal device 100 will be described. FIG. 5 is a data chart showing an example of data managed by the telephone call management section of the mobile radio terminal device according to the present embodiment.

Telephone number management section 112 of mobile radio terminal device 100 manages partners (names), partner telephone numbers, and partner terminal types that are registered in advance, as shown in FIG. 5.

As shown in FIG. 5, dual terminal judgment section 113 can identify whether or not the terminal type corresponding to the partner is a dual terminal device having a cellular interface and radio LAN interface based on the registration information cellular=1, radio LAN=0, dual terminal=1, or cellular=0, radio LAN=1, dual terminal=1, and can find the telephone numbers “01234” and “05678” of the partner “Ichiro Tamura.”

In addition, as shown in FIG. 5, dual terminal judgment section 113 can identify if the terminal type corresponding to the partner is a terminal device having only a cellular interface based on the registration information cellular=1, radioLAN=0, and dual terminal=0, and can find the telephone number “03333” of the partner “Jiro Kitamura.”

In addition, dual terminal judgment section 113, as shown in FIG. 5, can identify if the terminal type corresponding to the partner is a terminal device having only a radio LAN interface based on the registration information cellular=0, radio LAN=1, and dual terminal=0, and can find the telephone number “07777” of the partner “Saburo Sato.”

Furthermore, dual terminal judgment section 113, as shown in FIG. 5, can identify if the terminal type corresponding to the partner is a terminal type that does not match either of the above based on the registration information cellular=0, radio LAN=0, and dual terminal=0, indicating as the search result that there is no applicable partner or telephone number.

In this manner, dual terminal judgment section 113 can find the terminal type and telephone numbers corresponding to the partner based on the data registered in advance in telephone number management section 112 of mobile radio terminal device 100.

Thus, dual terminal judgment section 113 judges whether or not the transmission terminal type is a dual terminal from the identified terminal type and, based on the judgment result, notifies transmission number selection section 109 of one or two telephone numbers (see step ST202 of FIG. 3).

In addition, dual terminal judgment section 113 finds the terminal type corresponding to the partner telephone number delivered from telephone number management section 112 (step ST302 of FIG. 4) and, based on the search result, judges whether or not the terminal device of the partner is a dual terminal (step ST303 of FIG. 4).

Thus, when the user performs a transmission operation, mobile radio terminal device 100 according to the present embodimentjudges whether or not the partner is a dual terminal, and, if the partner is a dual terminal, performs transmission to each of the telephone numbers corresponding to the two radio interfaces of the partner.

In addition, when a reception request is detected on the cellular interface, mobile radio terminal device 100 according to the present embodiment judges whether or not the partner transmission is a dual terminal, and, if the partner transmission is a dual terminal, is capable of reception using the radio LAN interface if the radio LAN interface is connectable or the cellular interface if the radio LAN interface is not connectable.

Thus, mobile radio terminal device 100 according to the present embodiment is capable of making a connection via an interface automatically connectable to either the transmission side or reception side even when one of the interfaces of the dual terminal of the reception side is disabled for connection.

In addition, when both of the two interfaces of the dual terminal of the reception side are connectable, mobile radio terminal device 100 according to the present embodiment can make the connection using the radio LAN interface and selecting the communication line that is more advantageous from economic and communication speed standpoints.

In addition, mobile radio terminal device 100 according to the present embodiment does not require a selection function for the line connected to the network side and therefore can select a line on the terminal device side only, thereby realizing a communication system that is not dependent on network side service.

### EMBODIMENT 2

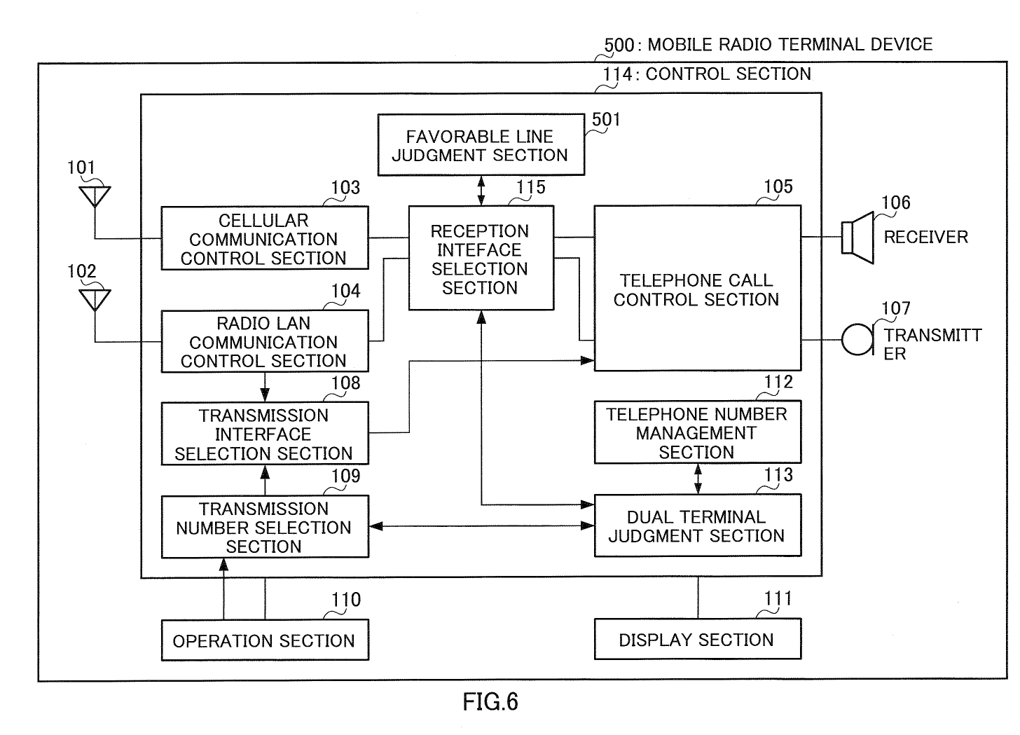

FIG. 6 is a block diagram showing the configuration of the mobile radio terminal device according to Embodiment 2 of the present invention. The components of mobile radio terminal device 500 of FIG. 6 that are common to those of mobile radio terminal device 100 shown in FIG. 2 are given with the same call-outs as those in FIG. 2 and detailed descriptions thereof are omitted. Mobile radio terminal device 500 of FIG. 6, in comparison to mobile radio terminal device 100 shown in FIG. 2, has a structure with favorable line judgment section 501 added.

Favorable line judgment section 501 judges, based on preset information, which system line and corresponding telephone number of cellular communication and radio LAN communication are more favorable for connection. Favorable line judgment section 501, with a time period rate table for each telephone system used as an example of possible preset information, selects the line with the more favorable rate based on the used telephone system and connection time.

Upon detection of a reception request on the cellular radio interface or radio LAN radio interface, reception interface selection section 115 outputs the telephone number of the partner of the reception request to dual terminal judgment section 113 and, based on the result of the judgment by dual terminal judgment section 113, outputs the received radio interface information to the favorable line judgment section if the terminal device of the partner is a dual terminal.

When favorable line judgment section 501 judges that connection using the received radio interface is more favorable, reception interface selection section 115 starts the reception process of the reception request of this radio interface.

On the other hand, when favorable line judgment section 501 judges that connection using the received radio interface is not more favorable, reception interface selection section 115 waits for the reception request on the other radio interface for a pre-determined period of time only.

Here, if the anticipated reception request of the radio interface arrives within the predetermined period of time, reception interface selection section 115 denies reception of the radio interface of the first reception request and starts the reception process of the reception request from the radio interface of the second reception request.

On the other hand, if the anticipated reception request from the radio interface does not arrive with the predetermined period of time, reception interface selection section 115 starts the reception process of the reception request from the radio interface of the first reception request.

Next, an example of the operation of control section 114 of mobile radio terminal device 500 at the time reception interface selection section 115 detects a reception request from cellular communication control section 103 or radio LAN communication control section 104 will be described.

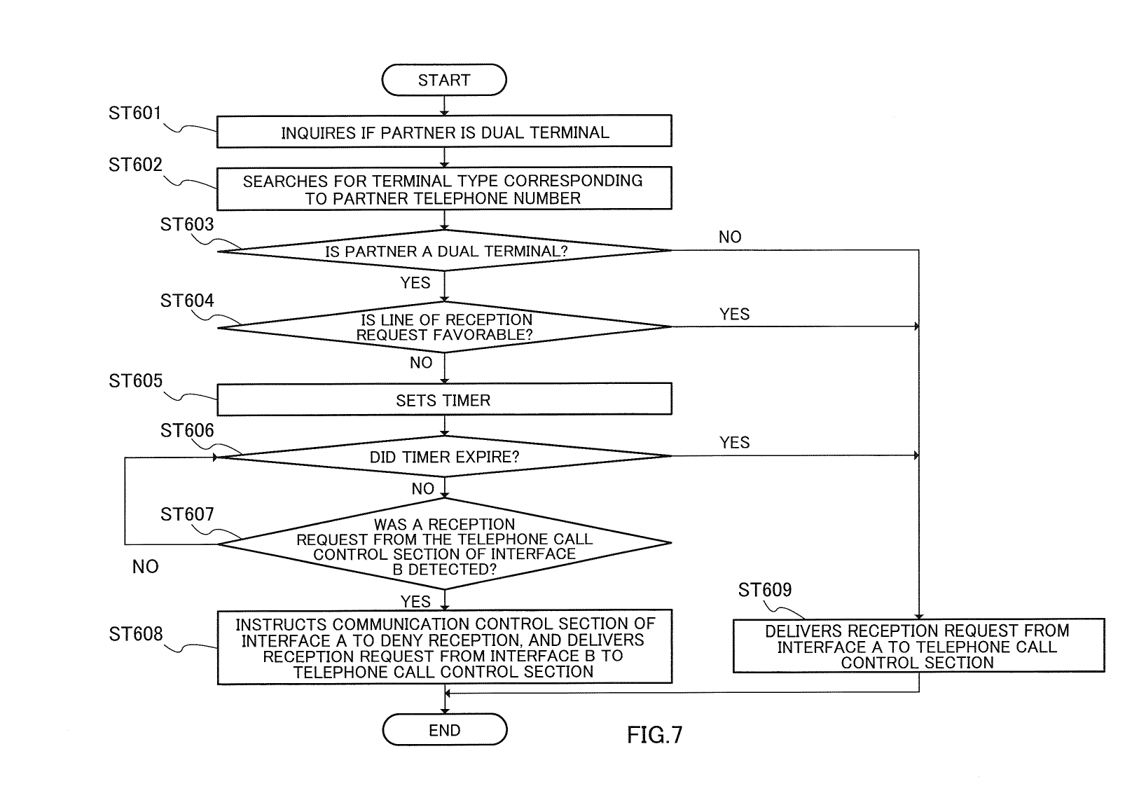

FIG. 7 is a flowchart for the operation of control section 114 upon detection of a reception request from a communication control section of the mobile radio terminal device according to the present Embodiment 2. Here, the interface corresponding to the communication control section that detects this reception request is referred to as interface A, and the other interface as interface B.

In FIG. 7, the operation of control section 114 begins when reception interface selection section 115 detects a reception request from the communication control section corresponding to interface A and, based on the partner telephone number of the reception request, inquires whether or not the terminal device of the partner is a dual terminal at dual terminal judgment section 113 (step ST601).

As a result, dual terminal judgment section 113 searches for the terminal type corresponding to the partner telephone number delivered from telephone number management section 112, judges whether or not the terminal type of the search result is a dual terminal, and delivers the judgment result to reception interface selection section 115 (step ST602).

When the partner terminal is a dual terminal according to the judgment result of dual terminal judgment section 113 (step ST603: Yes), reception interface selection section 115 inquires whether or not connection using the received radio interface is favorable at favorable line judgment section 501 and obtains the judgment result.

When the judgment result of favorable line judgment section 501 is “not favorable” (step ST604: No), reception interface selection section 115 sets a timer set to expire after a predetermined period of time (step ST605).

In addition, reception interface selection section 115 waits for a reception request from the communication control section corresponding to interface B (step ST607), up until the moment the above-mentioned timer expires (step ST606: No).

Next, when a reception request from the communication control section corresponding to interface B is detected before the above-mentioned timer expires (step ST607: Yes), reception interface selection section 115 instructs the communication control section corresponding to interface A to deny reception of reception requests detected by the interface, and delivers the reception request from interface B to telephone call control section 105 (step ST608).

As a result, telephone call control section 105 starts the reception process in accordance with the reception request from interface B. Subsequently, a message or symbol indicating reception appears on display section 111 and, if the user receives the display, operates operation section 110, and answers the reception, the telephone call starts.

On the other hand, if the above-mentioned timer expires in step ST606 (step ST606: Yes), reception interface selection section 115 delivers the reception request from interface A to telephone call control section 105 (step ST609).

As a result, telephone call control section 105 starts the reception process in accordance with the reception request delivered from reception interface selection section 115.

Subsequently, a message or symbol indicating reception appears on display section 111 and, if the user receives the display, operates operation section 110, and answers the reception, the telephone call starts.

Similarly, when the judgment result in step ST604 indicates that connection using the received interface is favorable (step ST604: Yes) and the judgment result of step ST603 indicates that the terminal device of the partner is not a dual terminal (step ST603), reception interface selection section 115 delivers the reception request from interface A to telephone call control section 105 (step ST609).

Then, telephone call control section 105 starts the reception process in accordance with the reception request delivered from reception interface selection section 115.

Subsequently, a message or symbol indicating reception appears on display section 111 and, if the user receives the display, operates operation section 110, and answers the reception, the telephone call starts.

In this manner, in the present embodiment, when a reception request is detected on one interface and the partner transmission is a dual terminal and both interfaces are connectable, connection is made using the favorable interface, thereby allowing selection of the communication line that is more advantageous from economic and communication speed standpoints.

In addition, mobile radio terminal device 500 according to the present embodiment does not require a selection function for the line connected to the network side and therefore can select a line on the terminal device side only, thereby realizing a communication system that is not dependent on network side service.

### EMBODIMENT 3

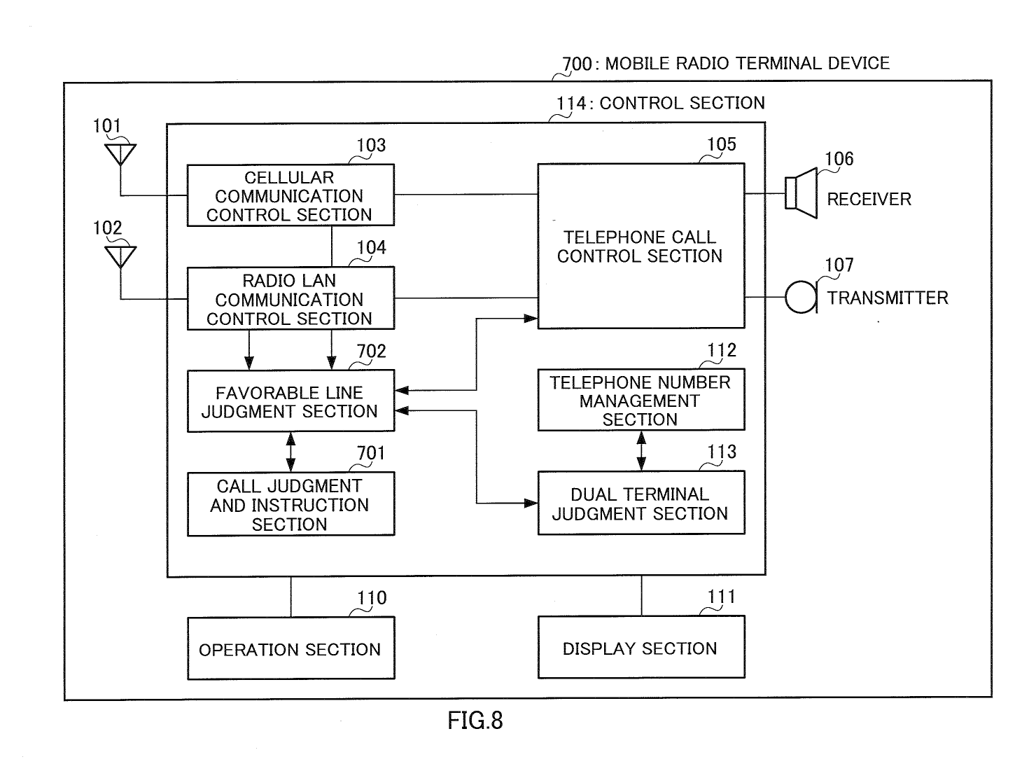

FIG. 8 is a block diagram showing the configuration of the mobile radio terminal device according to Embodiment 3 of the present invention. The components of mobile radio terminal device 700 of FIG. 8 that are common to those of mobile radio terminal device 100 shown in FIG. 2 are given the same call-outs as those in FIG. 2, and detailed descriptions thereof are omitted. Mobile radio terminal device 700 of FIG. 8, in comparison to mobile radio terminal device 100 shown in FIG. 2, has a structure with transmission interface selection section 108, transmission number selection section 109, and reception interface selection section 115 removed, and favorable line judgment section 701 and call judgment and instruction section 702 added. Furthermore, there is no problem with the addition of transmission interface selection section 108, transmission number selection section 109, and reception interface selection 115 to mobile radio terminal device 700 of FIG. 8.

Favorable line judgment section 701, based on preset information, judges whether or not use of the radio interface currently used for the telephone call is favorable over the other radio interface of mobile radio terminal device 700, and whether or not use of the partner telephone number currently used for the telephone call is favorable over the other telephone number held by the dual-mode terminal device of the partner. Here, a radio interface or telephone number is referred to as favorable if, for example, the communication or telephone call rate is inexpensive.

Call judgment and instruction section 702 connects the call path with the terminal device of the partner judged as a dual-mode terminal device by dual terminal judgment section 113 and, when the radio interface judged as favorable by favorable line judgment section 701 changes from a connection disabled state to a connection enabled state during a telephone call, instructs telephone call control section 105 to use the favorable radio interface, call the favorable partner telephone number, and connect the new call path. Furthermore, call judgment and instruction section 702 identifies that the radio interface judged as favorable by favorable line judgment section 701 has changed from a connection disabled state to a connection enabled state by periodically monitoring the radio waves between the present location and the base station of the radio service.

Furthermore, if the partner and new call path are connected, call judgment and instruction section 702 instructs telephone call control section 105 to disconnect the connection of the call path that was in use.

In addition, when the partner and new call path cannot be connected, call judgment and instruction section 702 periodically attempts connection based on a preset period of time.

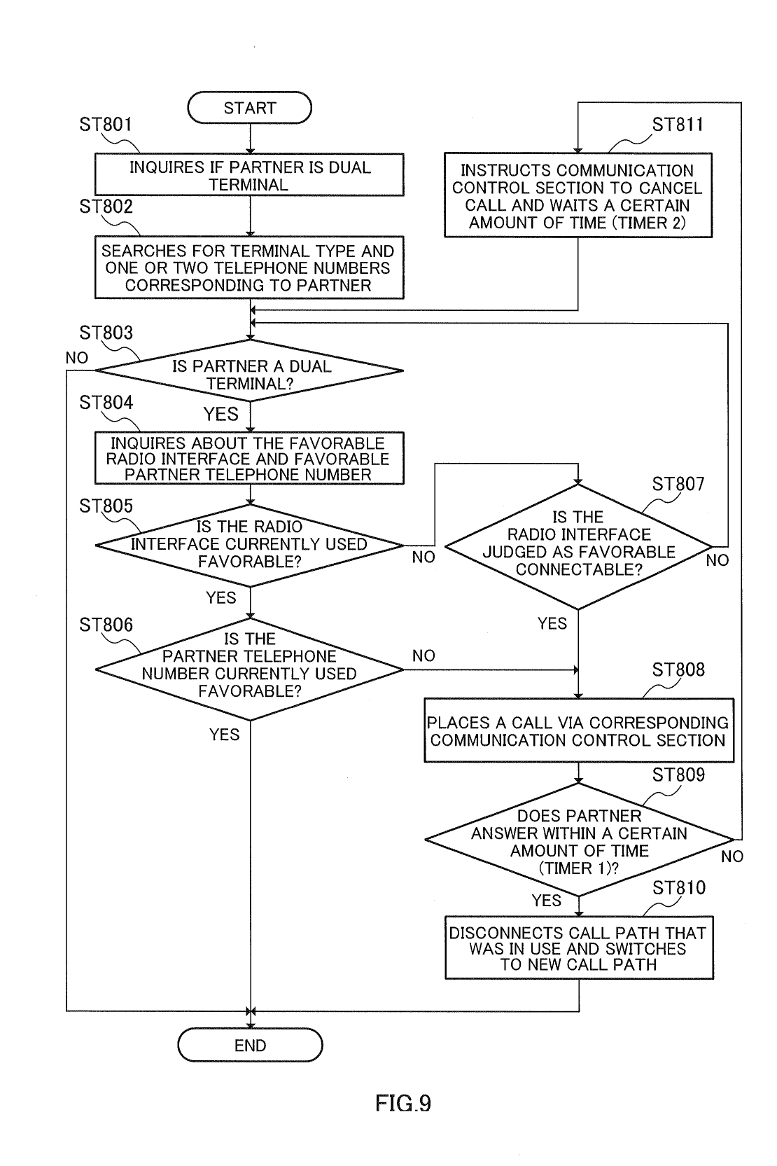

Next, an example of the operation of control section 114 at the time the user of mobile radio terminal device 700 connects a call path with the terminal device of a certain partner and the telephone call begins and is in progress will be described. FIG. 9 is a flowchart for the operation of control section 114 when a telephone call is in progress on the mobile radio terminal device according to Embodiment 3.

In FIG. 9, when the user of this mobile radio terminal device 700 connects a call path with the terminal device of a certain partner and the telephone call begins and is in progress, call judgment and instruction section 702 of control section 144 begins operation, first obtaining from telephone call control section 105 the partner telephone number of the telephone call in progress and the radio interface used by mobile radio terminal device 700.

Furthermore, call judgment and instruction section 702, based on the partner telephone number of the telephone call in progress, inquires whether or not the terminal device of the partner of the telephone call in progress is a dual terminal at dual terminal judgment section 113 (step ST801).

As a result, dual terminal judgment section 113 searches in the registration information registered in telephone number management section 112 for the terminal type and telephone number corresponding to the partner, and judges based on the terminal type of the search result whether or not the terminal device is a dual terminal. Then, dual terminal judgment section 113 notifies call judgment and instruction section 702 of the judgment result and one or two telephone numbers (step ST802).

Here, if the terminal type of the partner is a dual terminal, call judgment and instruction section 702 can extract two telephone numbers, i.e., the partner cellular telephone number and partner radio LAN telephone number.

Next, when the judgment result of dual terminal judgment section 113 indicates dual terminal (step ST803: Yes), call judgment and instruction section 702 inquires at favorable line judgment section 701 whether or not the radio interface currently used for the telephone call is favorable over the other radio interface of mobile radio terminal device 700, and whether or not the telephone number of the partner currently used for the telephone call is favorable over the other telephone number held by the dual-mode terminal device of the partner, and obtains the judgment results (Step ST804).

Next, when the judgment result of favorable line judgment section 701 indicates that use of the radio interface currently used for the telephone call is not favorable over the other radio interface of mobile radio terminal device 700 (step ST805: No), call judgment and instruction section 702 checks the connection status of the radio interface judged as favorable at the communication control section corresponding to that radio interface (step ST807).

Here, when the radio interface judged as favorable is in a connectable state (step ST807: Yes), call judgment and instruction section 702 instructs telephone call control section 105 to use the radio interface judged as favorable, call the partner telephone number judged as favorable, and connect the new call path.

In accordance with these instructions, telephone call control section 105 calls the partner telephone number via the corresponding communication control (step ST808).

Next, communication control section 105 waits a preset amount of time (set time period of timer 1) for a connection response from the partner. If there is a connection response from the partner within the set amount of time and telephone call control section 105 notifies call judgment and instruction section 702 that the partner and new call path have been connected (step ST809: Yes), call judgment and instruction section 702 instructs telephone call control section 105 to disconnect the connection of the call path that was in use and telephone call control section 105 disconnects the call path that was in use, switching the call path that was in use to the new call path (step ST810). Based on this operation, the call path is switched and the telephone call continues.

On the other hand, when telephone call control section 105 notifies call judgment and instruction section 702 that there was no connection response from the partner within the set amount of time (set time period of timer 1) (step ST809: No), call judgment and instruction section 702 instructs telephone call control section 105 to cancel the call instruction, and telephone call control section 105 cancels the call process. Furthermore, call judgment and instruction section 702 waits only a preset amount of time (set time period of timer 2) (step ST811). Subsequently, the process returns to step ST803 and the same process is repeated. In this manner, in the above-mentioned case where there is no connection response from the partner, the process is repeated and the partner is periodically (every set time period of timer 2) called in an attempt to connect the new call path.

In addition, when the radio interface judged as favorable is not in a connectable state (step ST807: No), the process returns to step ST803 and the same process is repeated.

In this manner, the process is repeated until the radio interface judged as favorable changes to a connectable state and, when the radio interface judged as favorable changes to a connectable state (step ST807: Yes), the partner is called and an attempt is made to connect the new call path as described above.

In addition, when the radio interface currently used for the telephone call is favorable (step ST805: Yes), call judgment and instruction section 702 checks if the telephone number of the partner currently used for the telephone call is favorable over the other telephone number held by the dual-mode terminal device of the partner based on the judgment result of favorable line judgment section 701 (step ST806).

When the telephone number of the partner currently used for the telephone call is not favorable over the other telephone number held by the dual-mode terminal device of the partner (step ST806: No), the process of step ST808 is performed.

When the telephone number of the partner currently used for the telephone call is favorable over the other telephone number held by the dual-mode terminal device of the partner (step ST806: Yes), the telephone call continues using the call path that was in use.

In addition, when the judgment result of step ST803 indicates that the terminal is not a dual terminal (step ST803: No), the process ends and the telephone call continues using the call path that was in use.

In this manner, in the present embodiment, when the radio interface judged as favorable during a telephone call becomes connectable, connection is made using the favorable interface, thereby allowing selection of the communication line that is more advantageous from economic and communication speed standpoints.

### EMBODIMENT 4

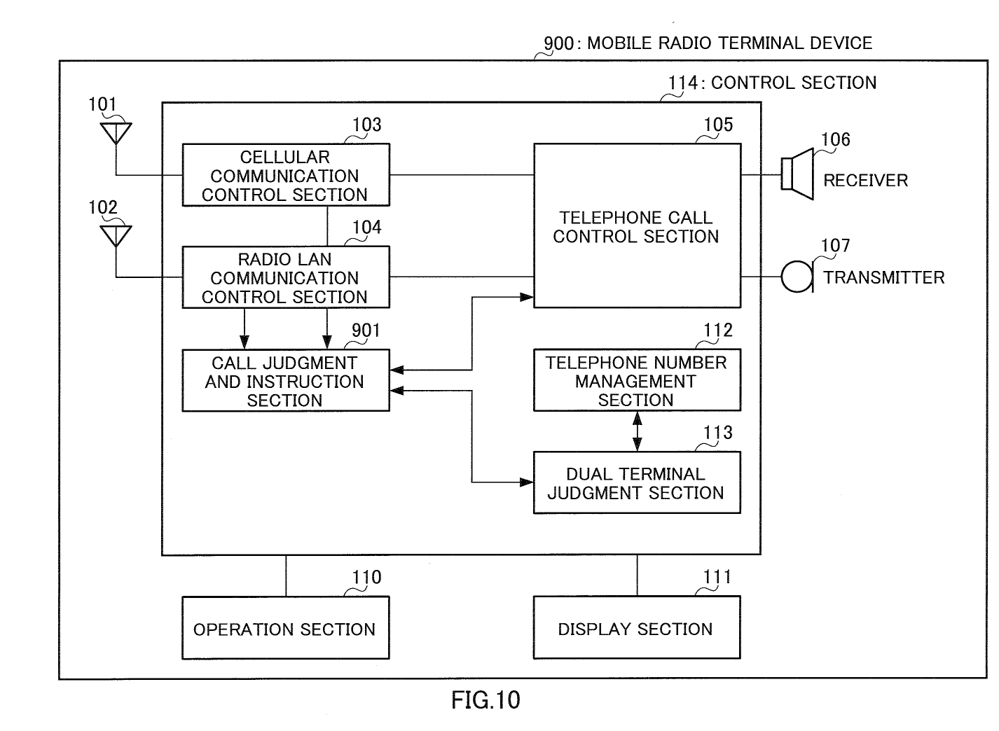

FIG. 10 is a block diagram showing the configuration of the mobile radio terminal device according to Embodiment 4 of the present invention. The components of mobile radio terminal device 900 of FIG. 10 that are common to those of mobile radio terminal device 100 shown in FIG. 2 are given the same call-outs as those in FIG. 2, and detailed descriptions thereof are omitted. Mobile radio terminal device 900 of FIG. 10, in comparison to mobile radio terminal device 100 shown in FIG. 2, has a structure with transmission interface selection section 108, transmission number selection section 109, and reception interface selection section 115 removed, and call judgment and instruction section 901 added. Furthermore, there is no problem with the addition of transmission interface selection section 108, transmission number selection section 109, and reception interface selection 115 to mobile radio terminal device 900 of FIG. 10.

Call judgment and instruction section 901 checks at cellular communication control section 103 and radio LAN communication control section 104 if the radio interface currently used for the telephone call over the other radio interface of mobile radio terminal device 900 is maintaining a preset quality and if the other unused radio interface is in a connectable state.

Furthermore, when the radio interface currently used for the telephone call is not maintaining a preset quality, call judgment and instruction section 901 instructs telephone call control section 105 to use the unused radio interface, call the partner telephone number, and connect the new call path.

Furthermore, if the partner and new call path are connected, call judgment and instruction section 901 instructs telephone call control section 105 to disconnect the connection of the call path that was in use.

In addition, if the partner and new call path cannot be connected, call judgment and instruction section 901 periodically attempts connection based on a preset period of time.

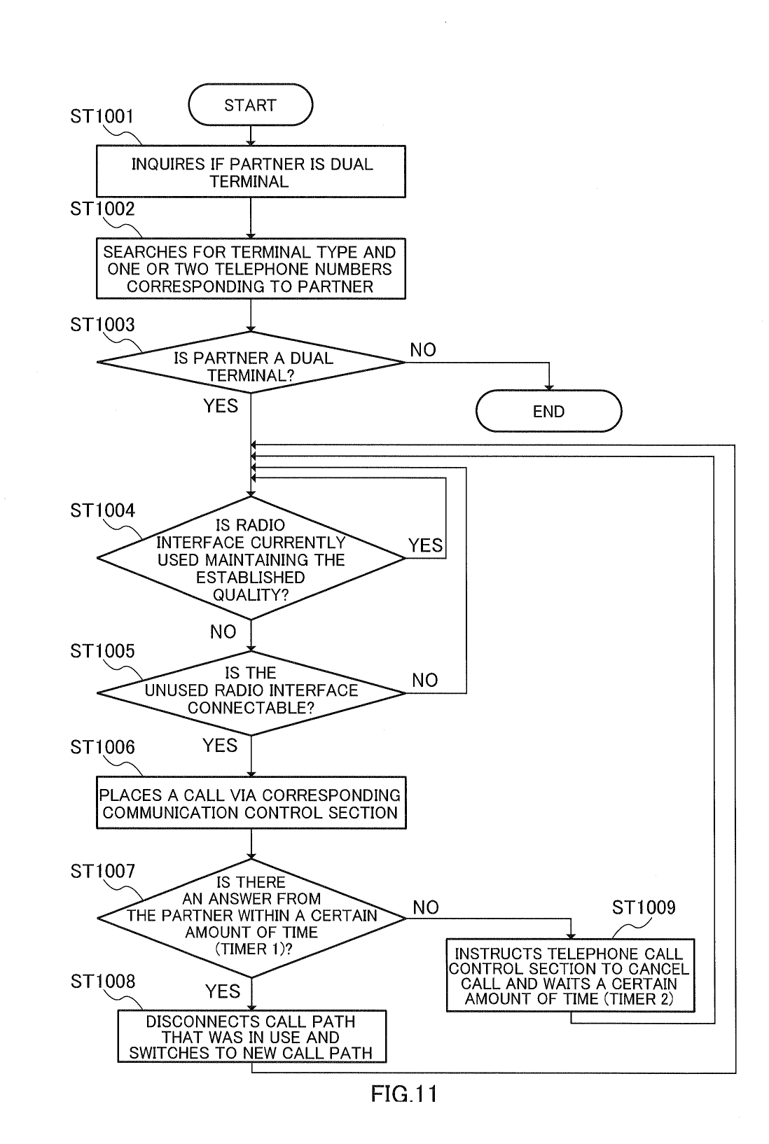

Next, an example of the operation of control section 114 at the time the user of mobile radio terminal device 900 connects a call path with the terminal device of a certain partner and the telephone call begins and is in progress will be described. FIG. 11 is a flowchart for the operation of control section 114 when a telephone call is in progress on the mobile radio terminal device according to Embodiment 4.

In FIG. 11, when the user of this mobile radio terminal device 900 connects a call path with the terminal device of a certain partner and the telephone call begins and is in progress, call judgment and instruction section 901 of control section 144 begins operation, first obtaining from telephone call control section 105 the partner telephone number of the telephone call in progress and the radio interface used by mobile radio terminal device 900.

Furthermore, call judgment and instruction section 901, based on the partner telephone number of the telephone call in progress, inquires whether or not the terminal device of the partner of the telephone call in progress is a dual terminal at dual terminal judgment section 113 (step ST1001).

As a result, dual terminal judgment section 113 searches in the registration information registered in telephone number management section 112 for the terminal type and telephone number corresponding to the partner, and judges based on the terminal type of the search result whether or not the terminal device is a dual terminal. Then, dual terminal judgment section 113 notifies call judgment and instruction section 901 of the judgment result and one or two telephone numbers (step ST1002).

Here, if the terminal type of the partner is a dual terminal, call judgment and instruction section 901 can extract two telephone numbers, i.e., the partner cellular number and the partner radio LAN number.

Then, if the judgment result of dual terminal judgment section 113 indicates that the terminal is a dual terminal (step ST1003: Yes), call judgment and instruction section 901 inquires at the corresponding communication control section if the radio interface currently used for the telephone call over the other radio interface of mobile radio terminal device 900 is maintaining a preset predetermined quality, and obtains the judgment result (step ST1004).

If the judgment result indicates that the predetermined quality is being maintained (step ST1004: Yes), this step ST1004 is repeated and whether or not quality is maintained is continually checked.

An example of a preset quality is the radio wave reception level, and an example of quality no longer maintained is when the radio wave reception weakens due to the movement of the user of the telephone call in progress, making it impossible for the telephone call to continue.

On the other hand, if the judgment result indicates that the predetermined quality is not being maintained (step ST1004: No), call judgment and instruction section 901 checks at the communication control section corresponding to the other unused radio interface the connection state of the radio interface, i.e., whether or not the interface is capable of transmission (step ST1005).

If check results indicate that the other unused radio interface is not capable of transmission (step ST1005: No), the process of this step ST1004 and the process of step ST1004 are repeated, continually checking if the other unused radio interface can be connected.

On the other hand, if the check result indicates that the other unused radio interface is capable of transmission (step ST1005: Yes), call judgment and instruction section 901 instructs telephone call control section 105 to use the unused radio interface, call the partner cellular number or partner radio LAN number, and connect the new call path. In accordance with these call instructions, telephone call control section 105 calls the partner telephone number via the corresponding communication control section (step ST1006).

Next, communication control section 105 waits a preset amount of time (set time period of timer 1) for a connection response from the partner. If there is a connection response from the partner within the set amount of time and telephone call control section 105 notifies call judgment and instruction section 901 that the partner and new telephone path have been connected (step ST1007: Yes), call judgment and instruction section 901 instructs telephone call control section 105 to disconnect the connection of the call path that was in use, and telephone call control section 105 disconnects the call path that was in use, switching the call path that was in use to the new call path (step ST1008). Based on this operation, the call path is switched and the telephone call continues. Subsequently, the process returns to step ST1004 and the same process is repeated. In this manner, the quality check is repeatedly performed for the new call path.

On the other hand, when telephone call control section 105 notifies call judgment and instruction section 901 that there was no connection response from the partner within the set amount of time (set time period of timer 1) (step ST1007: No), call judgment and instruction section 901 instructs telephone call control section 105 to cancel the call instruction, and telephone call control section 105 cancels the call process. Furthermore, call judgment and instruction section 901 only waits a preset amount of time (set time period of timer 2) (step ST1009). Subsequently, the process returns to step ST1004 and the same process is repeated. In this manner, in the above-mentioned case where there is no connection response from the partner, the process is repeated and the partner is periodically (every set time period of timer 2) called in an attempt to connect the new call path.

In this manner, in the present embodiment, a judgment is made when a telephone call is in progress as to whether or not the radio interface currently used is maintaining a predetermined quality and, if it is not and the unused radio interface is connectable, connection is made with the other radio interface, thereby allowing selection of the communication line that is more advantageous from economic and communication speed standpoints.

### EMBODIMENT 5

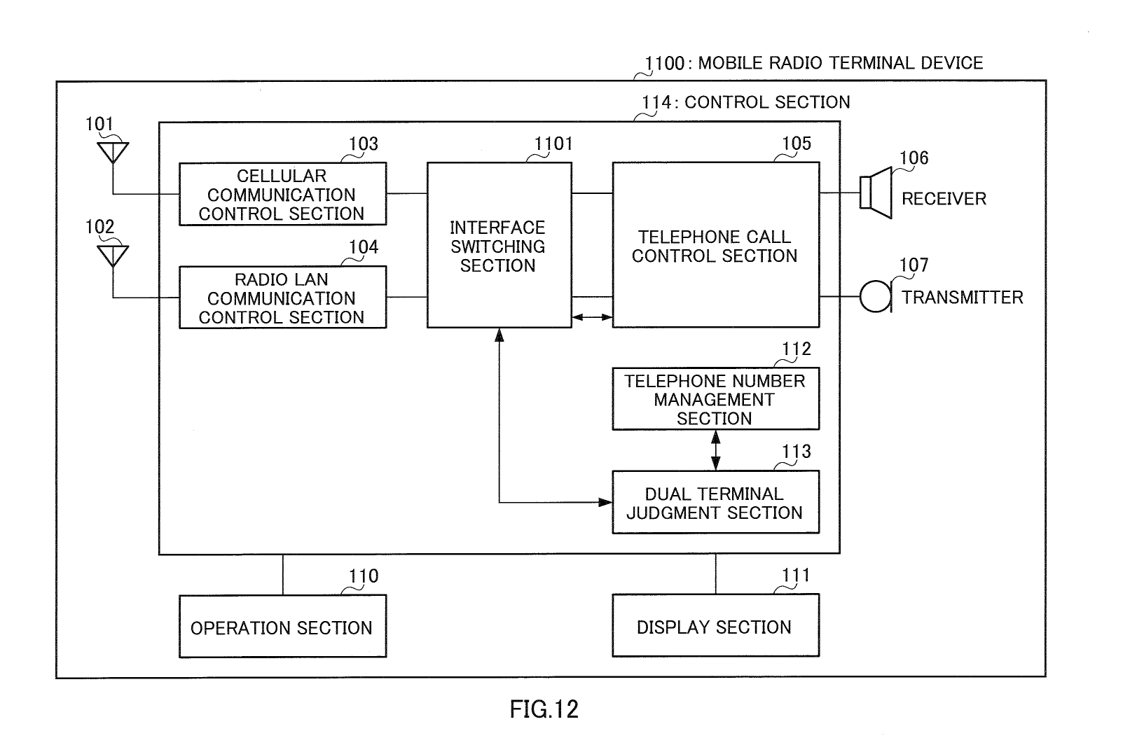

FIG. 12 is a block diagram showing the configuration of the mobile radio terminal device according to Embodiment 5 of the present invention. The components of mobile radio terminal device 1100 of FIG. 12 that are common to those of mobile radio terminal device 100 shown in FIG. 2 are given the same call-outs as those in FIG. 2, and detailed descriptions thereof are omitted. Mobile radio terminal device 1100 of FIG. 12, in comparison to mobile radio terminal device 100 shown in FIG. 2, has a structure with transmission interface selection section 108, transmission number selection section 109, and reception interface selection section 115 removed, and interface switching section 1101 added. Furthermore, there is no problem with the addition of transmission interface selection section 108, transmission number selection section 109, and reception interface selection 115 to mobile radio terminal device 1100 of FIG. 12.

When the user of mobile radio terminal device 1100 connects a call path with the terminal device of a certain partner and, while the telephone call is in progress, a reception request from cellular communication control section 103 or radio LAN communication control section 104 is detected, interface switching section 1101 inquires at dual terminal judgment section 113 whether or not the terminal device of the partner of the telephone call in progress is a dual-mode terminal device, and obtains one or two telephone call numbers of the partner.

Furthermore, if dual terminal judgment section 113 judges that the terminal device of the partner is a dual-mode terminal device and the telephone number of the reception request matches either of the two telephone numbers corresponding to the partner of the telephone call in progress, interface switching section 1101 instructs telephone call control section 105 to perform the reception process for the reception request and connect the new call path.

Furthermore, if the partner and new call path are connected, interface switching section 1101 instructs telephone call control section 105 to disconnect the connection of the call path that was in use.

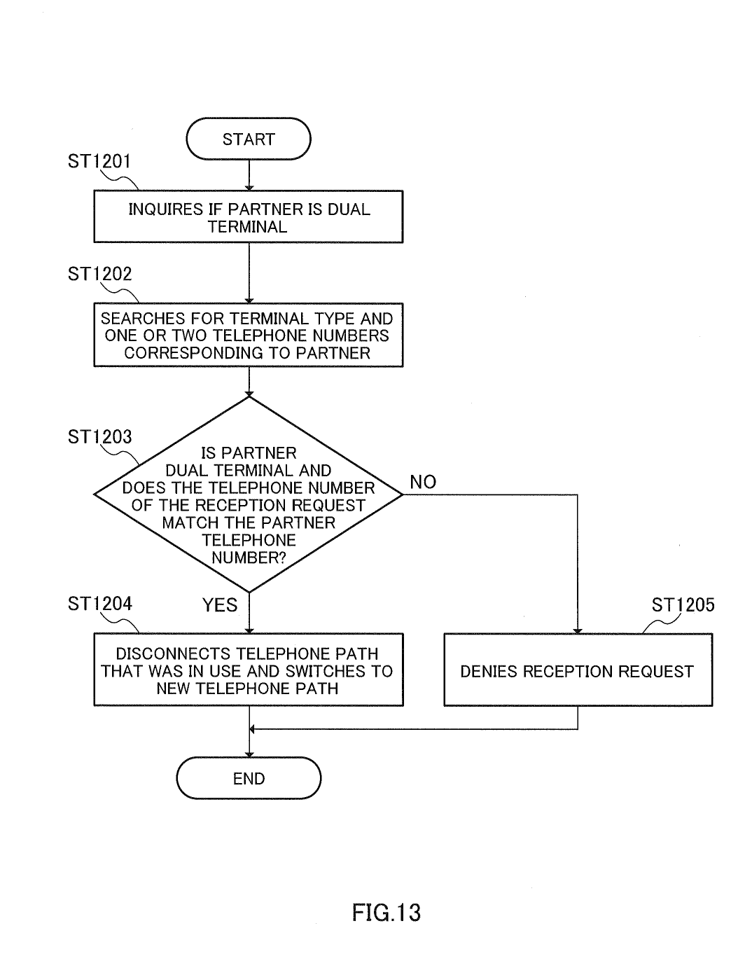

Next, an example of the operation of control section 114 at the time the user of mobile radio terminal device 1100 connects a call path with the terminal device of a certain partner and, while the telephone call is in progress, a reception request is detected from cellular communication control section 103 or radio LAN communication control section 104 will be described. FIG. 13 is a flowchart for the operation of control section 114 when a reception request from the communication control section is detected while a telephone call is in progress on the mobile radio terminal device according to the present Embodiment 5.

In FIG. 13, when a reception request from cellular communication control section 103 or radio LAN communication control section 104 is detected after the user of mobile radio terminal device 1100 connects a call path with the terminal device of a certain partner and the telephone call is in progress, the operation of interface switching section 1101 of control section 114 starts.

First, interface switching section 1101 obtains the telephone number of the partner of the telephone call in progress from telephone call control section 105. Furthermore, interface switching section 1101, based on the telephone number of the partner of the telephone call in progress, inquires whether or not the terminal device of the partner of the telephone call in progress is a dual terminal at dual terminal judgment section 113 (step ST1201).

As a result, dual terminal judgment section 113 searches in the registration information registered in telephone number management section 112 for the terminal type and telephone number corresponding to the partner, and judges based on the terminal type of the search result whether or not the terminal device is a dual terminal. Then, dual terminal judgment section 113 notifies interface switching section 1101 of the judgment result and one or two telephone numbers (step ST1202).

Here, if the terminal type of the partner is a dual terminal, interface switching section 1101 can extract two telephone numbers, i.e., the partner cellular number and the partner radio LAN number.

Then, if dual terminal judgment section 113 judges that the terminal device of the partner is a dual-mode terminal device and the telephone number of the reception request matches either of the two telephone numbers corresponding to the partner of the telephone call in progress, interface switching section 1101 instructs telephone call control section 105 to perform the reception process for the reception request and connect the new call path. Then, upon executing the reception process and connecting the new call path, telephone call control section 105 notifies interface switching section 1101 that the partner and new call path are connected.

Furthermore, upon reception of the notification indicating that the partner and new call path are connected from telephone call control section 105, interface switching section 1101 instructs telephone call control section 105 to disconnect the connection of the call path that was in use. Then, telephone call control section 105 performs the disconnection process and switches the call path that was in use to the new call path (step ST1204). Based on this operation, the call path is switched and the telephone call continues.

On the other hand, if the terminal device of the partner of the telephone call in progress is not a dual-mode terminal device, or if the telephone number of the reception request is neither of the two telephone numbers corresponding to the partner of the telephone call in progress (step ST1203: No), interface switching section 1101 instructs the communication control section of the reception request to deny reception (step ST1205). As a result, the reception request is refused and the telephone call in progress continues as is.

In this manner, in the present embodiment, when a reception request is detected on the cellular interface while a telephone call is in progress, a judgment is made as to whether or not the partner transmission is a dual terminal and, if the partner transmission is a dual terminal, the call path is switched to a new call path.

The present application is based on Japanese Patent Application No. 2004-232189, filed on Aug. 9, 2004, and Japanese Patent Application No. 2005-228924, filed on Aug. 5, 2005, the entire content of which is expressly incorporated by reference herein.

### INDUSTRIAL APPLICABILITY

The present invention makes a connection via a radio interface automatically connectable to a transmission side or a reception side even when one of the radio interfaces of the reception side is disabled for connection, and is therefore ideal for use in a dual-mode mobile radio terminal device.

1. A mobile radio terminal device that comprises a radio interface supporting a cellular mobile telephone system and a radio interface supporting a radio LAN system, comprising:
a telephone number management section that manages a telephone number and a terminal type of a partner that are registered in advance as registration information;
a dual terminal judgment section that judges based on the registration information of the telephone number management section whether the terminal device type corresponding to the telephone number of the partner is a dual-mode mobile radio terminal device comprising the two radio interfaces;
a reception interface selection section that, when the partner is judged as the dual-mode mobile radio terminal device by the dual terminal judgment section, detects a reception request by either of the mobile interfaces and, if there is a reception request on the other radio interface within a predetermined period of time, selects either of the radio interfaces, or, if there is no reception request on the other radio interface within the predetermined period of time, selects the radio interface that detected the reception request; and
a telephone call control section that starts the reception process of the reception request from the radio interface selected by the reception interface selection section, and connects the call path with the partner.

2. The mobile radio terminal device according to claim 1, wherein the reception interface selection section detects a reception request on either of the radio interfaces and, if there is a reception request on the other radio interface within a predetermined period of time, selects the radio interface supporting the radio LAN system.

3. The mobile radio terminal device according to claim 1 comprising a favorable line judgment section that judges, based on preset information, which system line and corresponding telephone number of the cellular mobile telephone system and radio LAN system are more favorable for connection,
wherein the reception interface selection section detects a reception request on either of the radio interfaces and, if there is a reception request on the other radio interface within a predetermined period of time, selects the radio interface supporting the system judged as favorable by the favorable radio judgment section.

4. The mobile radio terminal device according to claim 1 comprising:
a favorable line judgment section that judges, based on preset information, which system line and corresponding telephone number of the cellular mobile telephone system and radio LAN system are more favorable for connection; and
a call judgment and instruction section that, when the radio interface currently used is not favorable and the favorable radio interface becomes connectable during the telephone call, calls the partner from the favorable radio interface.

5. The mobile radio terminal device according to claim 1 comprising a call judgment and instruction section that, when the radio interface currently used does not maintain the predetermined quality and the other radio interface is connectable, calls the partner from the other radio interface.

6. The mobile radio terminal device according to claim 1 comprising an interface switching section that, when a telephone call is connected with the partner using a radio interface and a reception request from the presently connected partner is detected by the other radio interface, starts the reception process of the reception request from the radio interface of the reception request, connects the call path with the partner, and switches the line of the presently connected radio interface.

7. A mobile radio terminal device that comprises a radio interface supporting a cellular mobile telephone system and a radio interface supporting a radio LAN system, and serves as the partner of the mobile radio terminal device according to claim 1, comprising:
a telephone number management section that manages a telephone number and a terminal type of a partner that are registered in advance as registration information;
a dual terminal judgment section that judges based on the registration information of the telephone number management section whether the terminal device type corresponding to the telephone number of the partner is a dual-mode mobile radio terminal device comprising the two radio interfaces;
a transmission number selection section that extracts the telephone numbers corresponding to the radio interfaces of the terminal device of the partner;
a transmission interface selection section that, when the partner is judged as the dual-mode mobile radio terminal device by the dual terminal judgment section, selects the telephone number corresponding to the radio interface that is in a connected state over that of the other radio interface of the partner; and
a telephone call control section that transmits the telephone call to the telephone number selected by the reception interface selection section.
